(19) United States
(12) Patent Application Publication
(10) Pub. No.: US 2025/0007267 A1
(43) Pub. Date: Jan. 2, 2025

(54) COOLED BUSBAR FOR ELECTRIC POWER DISTRIBUTION

(71) Applicant: Tesla, Inc., Austin, TX (US)

(72) Inventors: Neil Prasad, Mountain View, CA (US); Whitney Mathews, Mountain View, CA (US); Jason Fishman, San Mateo, CA (US)

(21) Appl. No.: 18/703,911

(22) PCT Filed: Oct. 24, 2022
(86) PCT No.: PCT/US2022/047602

§ 371 Date: Apr. 23, 2024

Related U.S. Application Data
(60) Provisional application No. 63/263,322, filed on Oct. 29, 2021.

(51) Int. Cl. H02G 5/10; B60L 53/16; B60L 53/302

(52) U.S. Cl. CPC H02G 5/10; B60L 53/16; B60L 53/302

(57) ABSTRACT

Cooled busbars for electric power distribution are disclosed, in particular for electrical vehicles. The cooled busbar includes one or more conductive layers and one or more hollow portions (228). A cooling medium, such as a liquid coolant, can flow through the hollow portion(s). The cooled busbar includes a rigid conductor (223), an insulating layer (224) and a shielding layer (225).

### CROSS-REFERENCE TO RELATED APPLICATION

This application is a non-provisional of and claims priority to U.S. Provisional Patent Application No. 63/263,322, entitled “COOLED BUSBAR FOR ELECTRIC VEHICLE POWER DISTRIBUTION,” filed on Oct. 29, 2021, which is hereby incorporated by reference in its entirety and for all purposes.

### BACKGROUND

### Technical Field

The disclosed technology relates to electric power distribution. More particularly, the disclosed technology relates to power distribution within an electric vehicle.

### Description of Related Technology

Charging systems for electric systems, such as an electric vehicle or any electric system that involves electric power transfer from one or more electric power sources to one or more loads, can utilize flexible braided cables for conducting electricity from an electric power source to an electric power load. For example, the electric power can be transferred from a vehicle charging inlet (e.g., electric power source) to a vehicle battery (e.g., electric power load). These cable systems can provide high voltage and high current carrying capacity for high charging rates. These cables are typically flexible and contain braided metal, encapsulated by single or multiple layers of insulation and metal sleeving for touch safety and electromagnetic compatibility (EMC) shielding. As the need for electric power charging rates increases (e.g., electric vehicle charging rates), using flexible braided cables can present technical challenges.

### SUMMARY OF CERTAIN INVENTIVE ASPECTS

The innovations described in the claims each have several aspects, no single one of which is solely responsible for its desirable attributes. Without limiting the scope of the claims, some prominent features of this disclosure will now be briefly described.

One aspect of this disclosure is an electric power distribution system. The electric power distribution system includes a busbar. The busbar includes a rigid conductor configured to carry current from a source to a load, a hollow portion configured to have a cooling medium flow therethrough, an insulation layer, and a shielding layer.

The rigid conductor can include at least one of aluminum or cooper. The hollow portion can be surrounded by the rigid conductor. The insulation layer can provide electrical insulation. The insulation layer can further include at least one of cross-linked polyethylene (XLPE), polyvinyl chloride (PVC), nylon, silicone, thermoplastic, or thermoset plastic. The shielding layer can be electrically conductive. The insulation layer can also be positioned between the rigid conductor and the shielding layer.

The busbar in the electric power distribution system can include an inner tube layer and an electrically insulating layer. The electrically insulating layer is positioned between an inner diameter of the rigid conductor and the inner tube layer. The hollow portion can surround the outside of an outer diameter of the rigid conductor.

The rigid conductor can further include a first end and a second end, and the first end and the second end each have an electrical contact area.

The electric power distribution system can further include a coolant source, that the cooling medium flows from the coolant source to the busbar and from the second busbar to the coolant source.

The electric power distribution system can further include a U-Loop adaptor connected to the busbar and the second busbar that the second busbar is configured to provide return flow for the cooling medium.

The electric power distribution system can further include a reservoir and a pump together configured to provide the cooling medium to the hollow portion of the busbar.

The electric power distribution system can further include a charge-port connecting unit configured to connect the busbar to the source.

Another aspect of this disclosure is an electric vehicle that includes a battery, a charge port, and a busbar. The busbar can include a rigid conductor configured to carry current in an electrical path from the charge port to the battery, a hollow portion configured to have a cooling medium flow therethrough, an insulation layer, and a shielding layer.

Another aspect of this disclosure is a busbar that includes a conductor configured to carry electrical energy between components of an electric powertrain and a conduit for a cooling medium. The conductor and the conduit are both parts of a single busbar assembly. The busbar is a rigid busbar.

The cooling medium can include a liquid coolant.

The busbar can further include a second conduit.

The busbar can further include a second conductor and an insulating layer, the insulating layer positioned between the conductor and the second conductor.

The conductor in the busbar can include at least one of aluminum or copper.

The busbar can further include a shielding layer surrounding the conductor. The busbar can further include an insulation layer positioned between the conductor and the shielding layer.

The conduit in the busbar can include an electrically insulating layer configured to electrically isolate the conductor and coolant flowing through the conduit. The electrically insulating layer can include at least one of polyethylene, nylon, polyvinyl chloride, silicone thermoplastic, or thermoset plastic.

Another aspect of this disclosure is an electric vehicle that includes a first liquid cooled component configured to store electrical energy, a second liquid cooled component configured to utilize electrical energy, and a busbar in a pathway between the first liquid cooled component and the second liquid cooled component, the busbar comprising a rigid conductor configured to carry the electrical energy and a conduit configured to carry liquid coolant between the first liquid cooled component and the second liquid cooled component.

For purposes of summarizing the disclosure, certain aspects, advantages and novel features of the innovations have been described herein. It is to be understood that not necessarily all such advantages may be achieved in accordance with any particular embodiment. Thus, the innovations may be embodied or carried out in a manner that achieves or optimizes one advantage or group of advantages as taught herein without necessarily achieving other advantages as may be taught or suggested herein.

### BRIEF DESCRIPTION OF THE DRAWINGS

Embodiments of the present disclosure will be described, by way of non-limiting example, with reference to the accompanying drawings.

FIG. 1 depicts an embodiment of an electric charging system that includes a pair of cooled busbars.

FIG. 2A depicts a pair of cooled busbars.

FIG. 2B depicts a cross-sectional view of a cooled busbar, including an inner tube layer, a rigid conductor, and a first electrical insulation layer according to an embodiment.

FIG. 2C depicts a cross-sectional view of a cooled busbar, including an inner tube layer, a rigid conductor, a first insulation layer, and a second insulation layer according to an embodiment.

FIG. 2D depicts a cross-sectional view of the cooled busbar, including an inner tube layer, a rigid conductor, a first insulation layer, a second insulation layer, a shielding layer, and a coloring layer, according to an embodiment.

FIG. 2E depicts a perspective view of a cooled busbar with an electrical contact area and an insulation layer on an inside diameter of a rigid conductor according to an embodiment.

FIG. 2F depicts a side cross-sectional view of a cooled busbar with an electrical contact area and an insulation layer on an inner diameter of a rigid conductor as well as an inner tube layer on the inner diameter of the insulation layer.

FIG. 3A depicts a perspective view of a charge-port connecting unit and end portions of a pair of cooled busbars.

FIG. 3B depicts a transparent view of the U-Loop adaptor connected with a cooled busbar according to one embodiment.

FIG. 3C depicts another transparent view of the U-Loop adaptor connected with a cooled busbar according to one embodiment.

FIG. 4A depicts a perspective view of an embodiment of a load connecting unit and ends portions of a pair of cooled busbars.

FIG. 4B depicts perspective view of an embodiment of a pair of cooled busbars coupled to the load connecting unit of FIG. 4A.

FIG. 4C is a cross-sectional view depicting a pair of cooled busbars coupled to the load connecting unit of FIG. 4A.

FIG. 5A illustrates a perspective view of a pair of cooled busbars connected to a load.

FIG. 5B illustrates perspective view of an embodiment of a pair of cooled busbars.

FIG. 6 illustrates a diagram of an electrical power and coolant distribution system of an electric vehicle using the cooled busbar according to one embodiment.

FIG. 7 illustrates a cross-sectional layered view of an example embodiment of a multilayer cooled busbar, including two flat sides.

FIG. 8 illustrates a cross-sectional layered view of an example embodiment of a multilayer cooled busbar, including a conductive coolant tube layer.

FIG. 9 illustrates a cross-sectional layered view of an example embodiment of a multilayer cooled busbar, including multiple conductive layers.

FIG. 10 illustrates a cross-sectional layered view of an example embodiment of a multilayer cooled busbar with multiple coolant flow having more than one coolant flow direction.

FIG. 11 illustrates a cross-sectional layered view of an example embodiment of a multilayer cooled busbar with a round cross-section, including multiple conductors and coolant flow paths.

FIG. 12 illustrates a cross-sectional layered view of an example embodiment of a multilayer cooled busbar, including multiple conductors and a single coolant flow path.

FIG. 13A illustrates a cross-sectional view of an example embodiment of a busbar with more than one hollow portion around an inner rigid conductor.

FIG. 13B illustrates a perspective view of an example embodiment of busbars implementing one or more t hollow portions around an inner rigid conductor.

FIG. 14 illustrates perspective view of an example embodiment of a busbar with a rectangular shape with multiple inner rigid conductors and multiple hollow portions that surround the inner rigid conductors.

### DETAILED DESCRIPTION OF CERTAIN EMBODIMENTS

The following detailed description of certain embodiments presents various descriptions of specific embodiments. However, the innovations described herein can be embodied in a multitude of different ways, for example, as defined and covered by the claims. This description makes reference to the drawings where reference numerals can indicate identical or functionally similar elements. It will be understood that elements illustrated in the figures are not necessarily drawn to scale. Moreover, it will be understood that certain embodiments can include more elements than illustrated in a drawing and/or a subset of the illustrated elements. Further, some embodiments can incorporate any suitable combination of features from two or more drawings.

As discussed above, flexible stranded cables for conducting electricity in an electric system or component, such as an electric vehicle, can encounter technical challenges as the demand for charging rates (e.g., electric vehicle charging rates) increases. Busbars disclosed herein can be implemented in electric vehicles or any other suitable electric power distribution systems. Embodiments disclosed herein may be discussed with reference to electric vehicles for illustrative purposes, although any suitable principles and advantages disclosed herein can be implemented in any suitable electric power delivery system.

As demand increases for an electric vehicle with a high rate of charge, a cable with a larger cross-section area can be desirable. However, increasing the cross-section area of the cable can cause high costs in one or more of the raw materials, transportation and logistics constraints, vehicle packaging constraints, thermal losses, and vehicle range loss due to mass gains.

Embodiments of the present disclosure relate to a cooled busbar for an electric power distribution system, such as an electric power distribution system of an electric vehicle. The cooled busbar can carry high voltage. The cooled busbar can be shielded. The cooled busbar can distribute both electrical power and liquid/coolant within an electric vehicle.

For example, the cooled busbar can include one or more conductors and coolant extending from a point, such as an electric power source (e.g., electric power supply), to another point, such as an electric power load (e.g., motor). In this example, the conductor may deliver the electric power from the electric power source, such as a battery, to the electric power load, such as the motor, and the coolant can also flow between the electric power source to the load. Further, in this example, the coolant can be a coolant liquid and may cool the conductor when the conductor's temperature is increased due to the high power transfer in the conductor. Thus, the cooled busbar can transfer high electric power from a source to a load. The source is not limited to any specific power supply, and the source can include any suitable unit that provides electrical power to one or more electrical components in an electrical system, such as an electric vehicle.

In one embodiment, a pair of cooled busbars transfers electric power from the electric vehicle's charge port to a battery pack. A cooled busbar pair can run from the charge port to the battery pack. In some embodiments, the cooled busbar distributes electrical power from the battery pack to one or more electrical components in the vehicle. The cooled busbar can distribute electrical power from the battery pack to an electric vehicle's electrical power conversion system (PCS) and drive units in certain applications. In such applications, a cooled busbar pair may run from the battery pack to the front and/or rear drive units. In an embodiment, the battery pack, PCS, and drive units are connected through a pair of the cooled busbars. In this embodiment, the pair of the cooled busbars can distribute electrical power from the battery pack to PCS and drive units while circulating the coolant from a coolant reservoir to the battery pack, PCS, and drive units. The cooled busbars disclosed herein can be used in any suitable electrical system with electric power distribution.

The cooled busbar can provide at least an order of magnitude increase in system capability in the same packaging volume compared to a cable harness or solid core busbar. The cooled busbar can support high charging rates, such as 350 KW charging at 400V or 500 kW charging at 800V. Keeping the busbar's temperature below the busbar material's temperature limit can contribute to achieving such high charging rates. With the cooled busbars, faster charging times can be achieved than with certain other busbars, and the faster charging times can be at a lower temperature. The cooled busbars can contribute to faster charging, higher throughput through charging stations, and driving down system costs. The cooled busbar may include liquid as its cooling medium. Moreover, the cooled busbar may transfer both electrical power and liquid. Thus, some thermal lines in a conventional electric vehicle that are separate from electrical charging lines may be eliminated.

In some embodiments, the cooled busbar comprises a rigid conductor and an inner tube layer. An electrical insulation layer can surround the rigid conductor. In some embodiments, the material for the rigid conductor can include any suitable conductive material, such as aluminum, copper, bronze, brass, gold, silver, the like, or any suitable combination or alloy thereof. The rigid conductor can comprise one or more hollow portions. Such a hollow portion of the rigid conductor can be fitted over the inner tube layer, allowing for the passage of a cooling medium for active and/or passive cooling. In one embodiment, the cooling medium can be a liquid coolant. In one embodiment, the cooling medium can be passive cooling using phase change materials such as hydrated salts or paraffin wax. In one embodiment, the cooling medium is made of a dielectric material. For example, a dielectric material can be included inside the hollow portion of the rigid conduct, and the inner tube can be eliminated. The cooling medium can be air in some instances. Any suitable material can be utilized as a cooling medium of the cooled busbar for a particular application.

In some embodiments, the electrical power is distributed through the rigid conductor, and the liquid is distributed through the inner tube layer. In these embodiments, the cooled busbar distributes both the electrical power and coolant, so electrical power cable and thermal hoses from some other electric vehicles can be replaced by the single cooled busbar. During the electrical power transfer, the liquid can flow through the inner tube layer, keeping the rigid conductor's temperature below the busbar's (e.g., cooled busbar's) temperature limit. Thus, high electrical power can be transferred without increasing the cross-section area of the rigid conductor. In some embodiments, the liquid may be supplied from a vehicle's liquid reservoir, such as a coolant reservoir. Such a reservoir can be a dedicated reservoir for the busbar. Alternatively, a liquid reservoir can also be used for another purpose, such as cooling a battery or another component of an electric vehicle. Such a shared reservoir can have a dedicated port for interfacing with the cooled busbar. The liquid can alternatively or additionally be supplied from a vehicle's radiator, where the radiator cools the liquid. A pump can cause the liquid to follow from a liquid source through a channel defined by one or more hollow portions of a busbar. Examples of the liquid include but are not limited to water, oil, and other liquids or solutions. The liquid may be selected based on its thermal conductivity or heat capacity.

In some embodiments, an electrical insulation layer may be lined between the inner tube layer and the rigid conductor. The inner tube layer can be electrically isolated and thermally conductive. The inner tube layer can be made of any suitable thermally conductive material, such as aluminum. In one embodiment, the inner tube layer is made of an electrically non-conductive material such as a thermoplastic or thermoset plastic. In one embodiment, the inner tube layer is a coated layer on the inside diameter of the rigid conductor.

The insulated rigid conductor can be surrounded by a shielding layer. The shielding layer provides a shield for electromagnetic interference (EMI) and protection for the cooled busbar from damage. The shielding layer may be flexible or rigid. When the shielding layer is rigid, the shielding layer can provide physical protection for the insulation layer from an external condition and/or damage during a 3-D bending process. The shielding layer can be made of any suitable EMI shielding material, such as aluminum, electrically conductive plastic, carbon fiber, stainless fiber, etc. In some embodiments, the shielding layer may be grounded to the vehicle's Body in White (BIW). This can provide an isolation loss detection in the event of a high voltage short circuit.

In some embodiments, various cross-sectional shapes of the rigid conductor can enhance and/or optimize liquid flow and increase and/or maximize the electrical power transfer rate. In one embodiment, the rigid conductor has a circular cross-section and a circular hollow portion, wherein the hollow portion fits the inner tube layer.

In some embodiments, the electrical insulation layer may be made of any electrically insulating material, such as cross-linked polyethylene (XLPE), PVC, silicone, or plastic. In one embodiment, the electrical insulation layer may be applied via an assembly method such as heat-shrink or extrusion process.

In some embodiments, more than one cooled busbar is run together with (e.g., in parallel with) another cooled busbar to transfer relatively high electrical power. Although embodiments may be discussed with two cooled busbars for illustrative purposes, any suitable principles and advantages disclosed herein can be applied to applications with more than two cooled busbars and/or applications with a single cooled busbar. In one embodiment, parallel cooled busbars may run from the electric vehicle's charge inlet to a connecting unit in the battery pack. In the embodiment, the connecting unit includes a liquid supply port and return ports. For example, a pump at or near the connecting unit can supply the liquid to the inner tube layer of one of the parallel cooled busbar. Then, the liquid flows into the inner tube layer of another cooled busbar to return to a liquid reservoir at or near the connecting unit.

Technology disclosed herein can be applied to a variety of applications. For example, in addition to using the coolant to cool the conductor, busbars disclosed herein can carry coolant between different parts and/or components of an electric vehicle. This can eliminate parallel routing of power distribution and coolant. As another example, multiple conductors and/or multiple fluid conduits can be included in a single busbar.

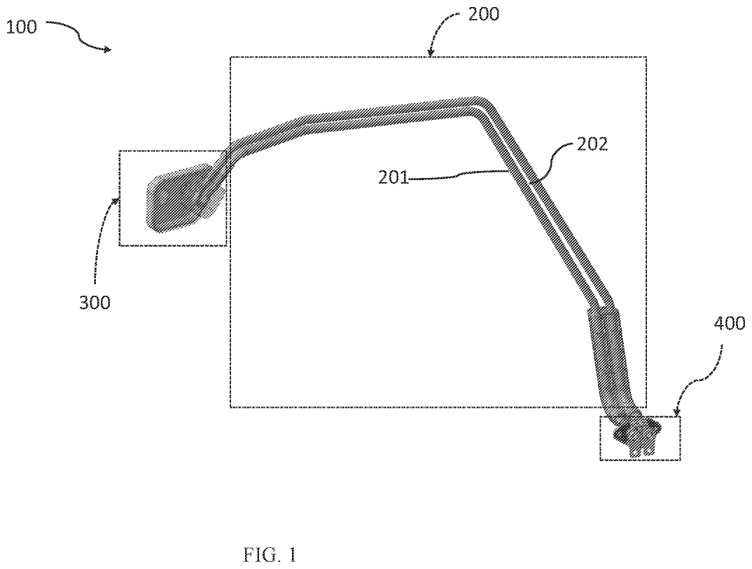

FIG. 1 illustrates a high power transferring system 100 of an embodiment of high electrical power transfer using a pair of cooled busbars 200. The cooled busbars 200 can be implemented in an electric vehicle, such as a car, a sport utility vehicle, a truck, or any other electric vehicle. The pair of cooled busbars 200 includes a first and a second cooled busbar 201, 202. The cooled busbars 201, 202 include an electrical conductor on which power is concentrated for distribution in an electronic power distribution system, such as in an electric vehicle. The cooled busbars 201, 202 are rigid and retain their shape. With rigid cooled busbars 201, 202, routing brackets and clips may not be needed. Assembly can be easier with rigid cooled busbars 201, 202 in a factory assembly environment relative to flexible harnesses. The cooled busbars 201, 202 can carry direct current (DC) power, alternating current (AC) power, or AC and DC power. Raw material for the cooled busbars 201, 202 can be densely packed and shipped directly from a supplier to the site of installation to bend to conform to in-vehicle packaging. Accordingly, processing of cables and connectors from some previous busbars is not needed.

As illustrated in FIG. 1, the pair of cooled busbar 200 connects a charge-port connecting unit 300 and a connecting unit 400, where the connecting unit 400 is connected to a load, such as a battery pack. The connecting unit 400 is an example of a load connecting unit that connects a busbar to a load. The length and route of the cooled busbars 201, 202 may be determined based on the vehicle's underbody design or curvature and the location of the electrical power source and load within the vehicle.

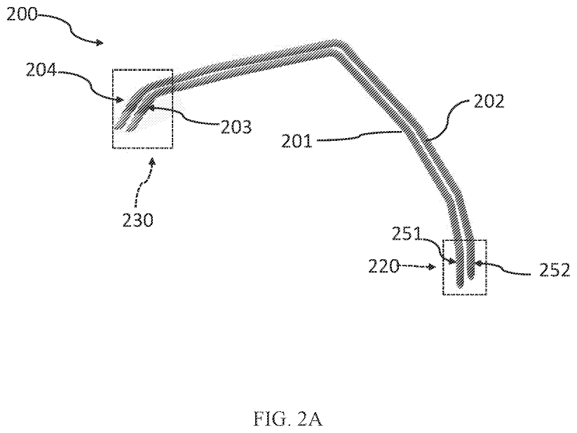

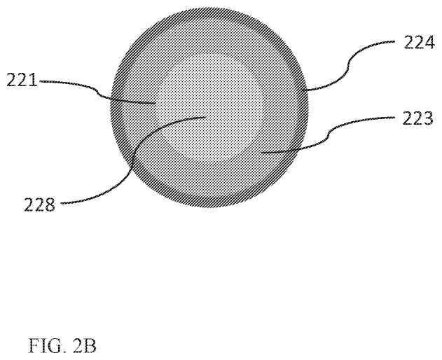

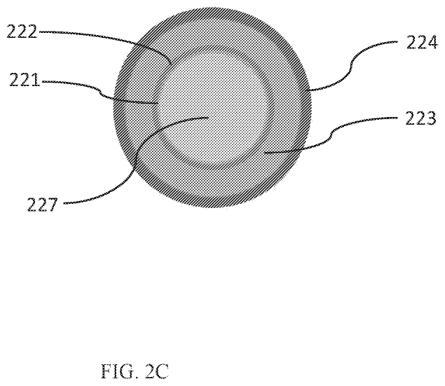

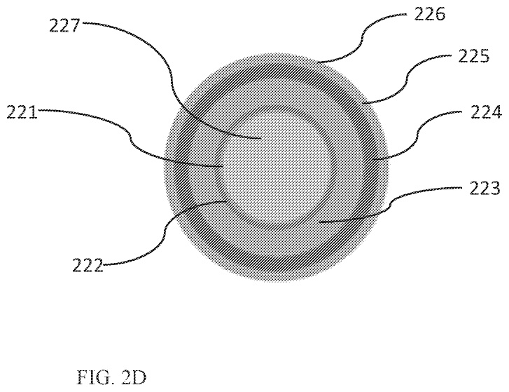

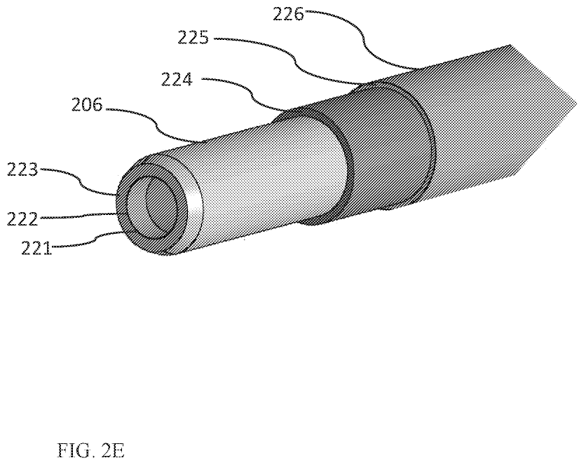

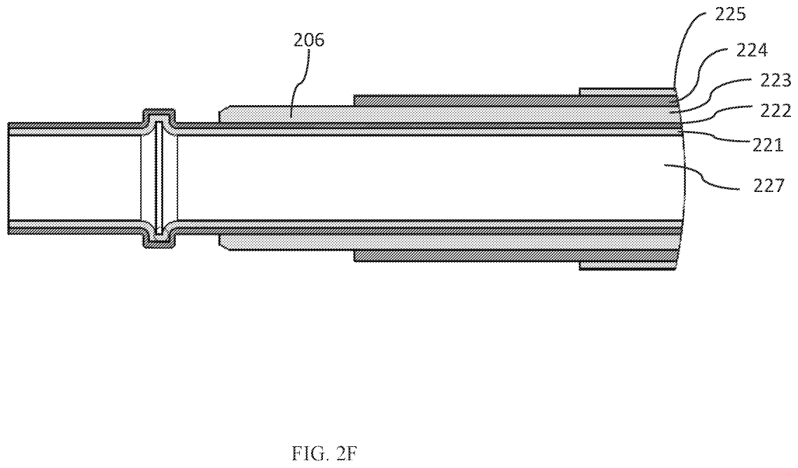

FIG. 2A depicts the pair of cooled busbars 200. As illustrated, the pair of busbars 200 includes a source end 230 and a load end 220. In FIG. 2A, the source end 230 and the load end 220 are positioned toward an electrical power source and a load, respectively. The position of the load end 220 and the source end 230 may be selected based on the vehicle's physical attributes, such as the location of the electrical power source and load. For example, the load end 220 can be positioned in one direction toward the load such as an electric vehicle battery. The source end 230 can be positioned in the opposite direction toward electrical power source, such as an electric vehicle charging port.

FIGS. 2B-2D depict cross-sectional view of various embodiments of the cooled busbar 201. In some embodiments, for example, as shown in FIG. 2B, the cooled busbar 201 comprises a rigid conductor 223 and an inner tube layer 221, where a first electrical insulation layer 224 surrounds the rigid conductor 223. The rigid conductor 223 further comprises one or more hollow portions 228. In FIG. 2B, the hollow portion 228 is fitted inside the surface of the inner tube layer 221, which allows a cooling medium to pass through for active or passive cooling. The hollow portion 228 can function as a tube for liquid coolant to flow through. The rigid nature of the busbar 201 can provide a rigid channel for the liquid coolant flow. In some embodiments, the inner tube layer 221 may be made of a thermally conductive material, such as aluminum. The rigid conductor 223 may be made of any suitable conductive material, such as aluminum or copper.

In some embodiments, for example, as shown in FIG. 2C, a second insulation layer 222 may be included between the inner tube layer 221 and the rigid conductor 223 in addition to the embodiment as described in FIG. 2B. The second insulation layer 222, as shown in FIG. 2C, can provide electrical isolation between the inner tube layer 221 and the rigid conductor 223.

In some embodiments, for example, as shown in FIG. 2D, the rigid conductor 223 is surrounded by a shielding layer 225. The shielding layer 225 can provide a shield against electromagnetic interference. Such shielding can protect the rigid conductor 223 from damage. The shielding layer 225 may be flexible or solid. The shielding layer 225 can be made of any suitable EMI shielding material, such as aluminum. In some embodiments, the shielding layer 225 can provide physical protection for the insulation layer from an external condition and/or damage during a manufacturing process, such as 3-D bending process. In some embodiments, the shielding layer 225 may be grounded to a vehicle's Body in White (BIW). This can provide an isolation loss detection in the event of a high voltage short circuit. The shielding layer 225 can be surrounded by a coloring layer 226. The coloring layer 226 can provide a specific color for each cooled busbar, so each cooled busbar can be distinguishable from other cooled busbars based on the color of the coloring layer 226.

In the depicted embodiments, as shown in FIGS. 2B-2D, the inner tube layer 221 may be made of any thermally conductive material, such as aluminum. The rigid conductor 223 may be made of any suitable conductive material, such as aluminum or copper. The first and second insulation layers 224, 222 may each be made of any suitable electrically insulating material, such as XLPE, PVC, nylon, silicone, or plastic. In one embodiment, the first and second insulation layers 224, 222 may be applied via an assembly method such as heat-shrink, extrusion, or coating process. The shielding layer 225 may be flexible or solid and made of any suitable EMI shielding material, such as aluminum or any suitable conductive material, including EMI plastic. The coloring layer 226 of FIG. 2D may be made of any suitable electrically insulating material with any suitable color coating. Liquid 227 can be present in the hollow portion 228 of a bus bar. The liquid 227 may be selected based on its thermal conductivity or heat capacity. Examples of liquid 227 include, but are not limited to, water, oil, and other liquids and/or solutions for cooling. Any other suitable cooling medium can be used in place of the liquid 227, such as air, a solid, or phase change material, such as hydrated salts or paraffin wax.

In some embodiments, various cross-sectional shapes of the rigid conductor 223 may be used to enhance and/or maximize the electrical power transfer rate. For example, the rigid conductor 223 may have a rectangular cross-sectional shape. In some embodiments, the rigid conductor 223 may have more than one hollow portion to increase and/or optimize the liquid 227 flow. In this embodiment, the hollow portions can also be used to achieve bidirectional flow.

FIGS. 2E and 2F depict an electrical contact area 206 of a busbar. In the depicted embodiments, the end of the first and second cooled busbar 201, 202 each have the electrical contact area 206. In these embodiments, the rigid conductor 223 is exposed, and the exposed surface of the rigid conductor 223 forms the electrical contact area 206. The electrical contact areas 206 in both ends of the cooled busbar 201, 202 are coupled with proper positive and negative terminals in the charge-port connecting unit 300 and the connecting unit 400. Any suitable end-connecting unit for transferring power can be used in place of the charge-port connecting unit 300 in various applications. The busbar of FIG. 2E includes insulation layer 222 on an inside diameter of the rigid conductor 223. The busbar of FIG. 2F includes insulation layer 22 on an inner diameter of the rigid conductor 223 as well as an inner tube layer 221 on the inner diameter of the insulation layer 222. The inner tube layer 221 can protect from corrosive fluid mediums, etc.

The cooled busbars disclosed herein can be connected to various connecting units to connect to a source and to connect to a load. Cooled busbars can be compatible with connecting units for other busbars in certain applications. Accordingly, cooled busbars disclosed herein can have backward compatibility with various connecting units and charging ports.

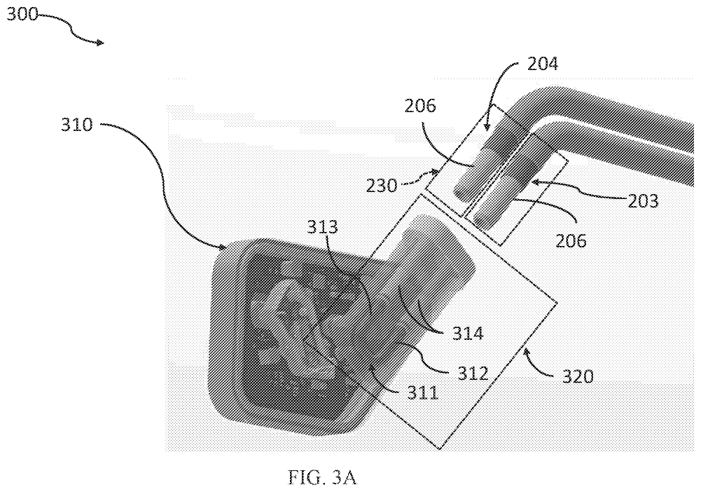

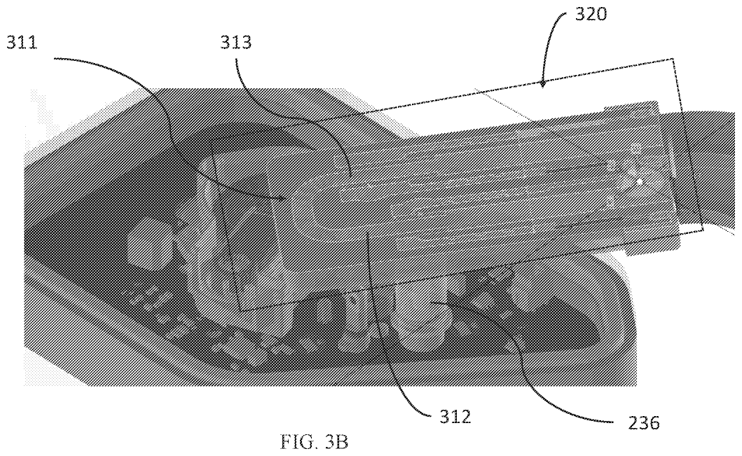

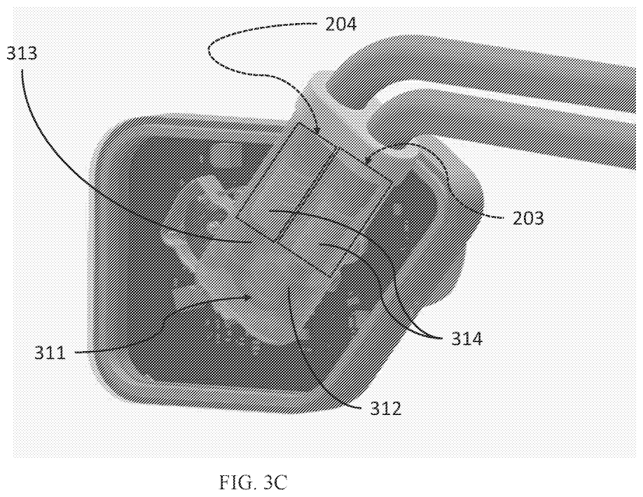

FIG. 3A depicts a charge-port connecting unit 300 and end portions of cooled busbars, such as the source end 230. As illustrated, the charge-port connecting unit 300 has a U-Loop adaptor 320 implemented in a charging port 310 configured to receive electrical power. The first busbar end 203 and the second busbar end 204 can be connected to U-Loop adaptor 320. For example, as shown in FIG. 3A, the electrical contact areas 206 of the source end 230 can be inserted into the U-Loop adaptor 320. The U-Loop adaptor 320 includes a U-Loop 311, whereas the U-Loop 311 comprises a first U-Loop arm 312 and a second U-Loop arm 313. The U-Loop adaptor 320 may include canted coiled springs 314, where each of the canted coiled spring 314 can be connected with the first and second U-Loop arms 312, 313 and configured to surround one of the electrical contact areas 206.

FIGS. 3B and 3C depict views of the U-Loop adaptor 320. As illustrated, the first busbar end 203 and a second busbar end 204 are molded in parallel inside the U-Loop adapter 320. In one embodiment, the first busbar end 203 is connected to the first U-Loop arm 312, and the second busbar end 204 is connected to the second U-Loop arm 313. The connection between the first and second busbar ends 203, 204, and the U-Loop 311 can be altered based on application. As shown in FIG. 3B, the U-Loop adaptor 320 can include a first forged terminal 236. The U-loop adaptor 320 can also include a second forged terminal (not shown in FIG. 3B). One end of a first and the second forged terminal can be molded in the U-Loop adaptor 320. The other ends of the forged terminals can be connected to a charge-port terminal. An electric vehicle can receive the electrical power through the charge-port terminals from external electrical power sources, such as a supercharging station. The electrical contact areas 206 in the first and second busbar ends 203, 204 shown in FIG. 3A can be coupled to the forged terminals 236 and surrounded by canted coiled springs 314. The diameter of the first and second U-Loop arms 312, 313 can be smaller than the inner tube diameter in the first and second busbar ends 203, 204. The loop in the U-Loop adaptor 320 can return flow when one busbar is used for supplying coolant, and the other busbar is used for returning the coolant. In some other embodiments without a U-flow, coolant can continue elsewhere after traveling to the source or load.

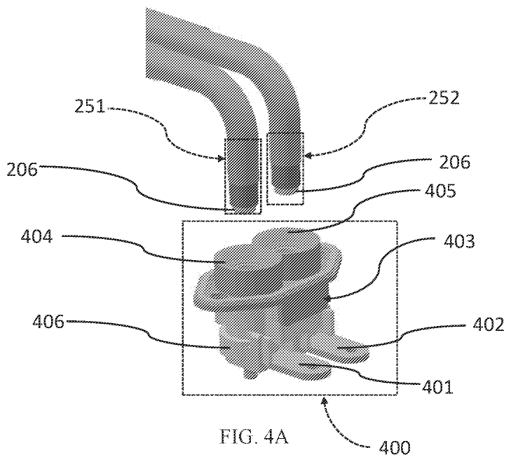

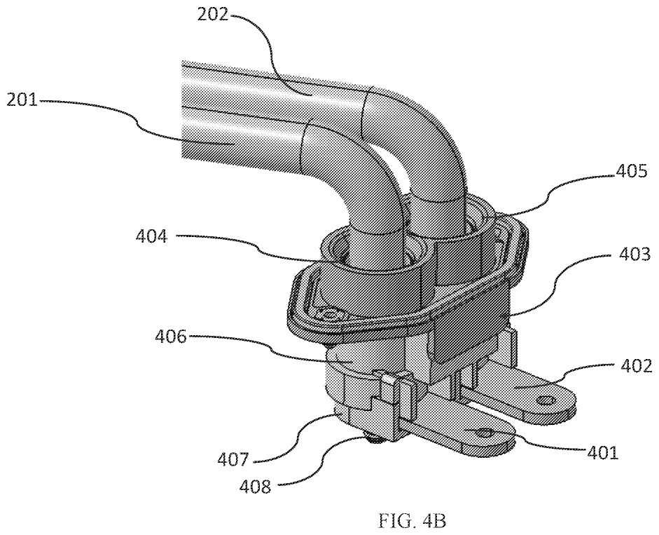

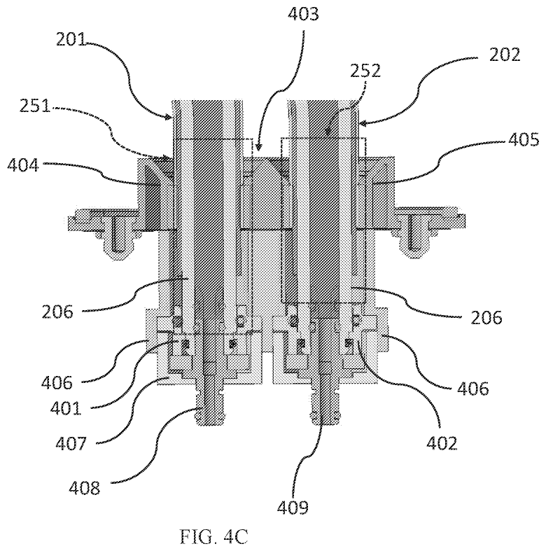

FIG. 4A depicts a load connecting unit and end portions of a pair of cooled busbars. The load connecting unit is shown as the connecting unit 400 in FIG. 4A. The illustrated connecting unit 400 includes a header 403, a connect insulator 406, a first plug 401, and a second plug 402. In FIG. 4A, a first busbar head 251 and a second busbar head 252 each have an electrical contact area 206. The connecting unit 400 and the U-loop adaptor 320 of FIGS. 3A and 3B can be connected to opposing ends of cooled busbars.

FIG. 4B depicts an embodiment that the first and second cooled busbars 201, 202 are coupled to the connecting unit 400. The electrical contact area 206 in the first busbar head 251 is coupled to the first plug 401. The electrical contact area 206 in the second busbar head 252 is coupled to the second plug 402. The connection between the first and second busbar heads 251, 252, and the first and second plugs 401, 402 can be altered based on application.

FIG. 4C depicts a cross-section of the connecting unit 400 coupled to cooled busbars 201, 202. In the depicted embodiment, the first busbar head 251 is coupled to a first fitting member 408, and the second busbar head 252 is connected to a second fitting member 409. This embodiment also shows that the electrical contact area 206 in the first and second busbar heads 251, 252 are coupled with the first and second plugs 401, 402. In one embodiment, one ends of the first and second plugs 401, 402 are plugged into a DC terminal in the battery pack, where the other ends of the first and second plugs 401, 402 are molded inside the back cap 407. In the embodiment, the first and second busbar heads 251, 252 can be inserted into the first and second liquid headers 404, 405, so that the electrical contact area 206 in the first and second busbar heads 251, 252 can be contacted to the first and second plugs 401, 402. The connecting unit 400 can provide a pass-through for the cooled busbars 201, 202. The connecting unit 400 can split the cooling medium from the current carrying electrical contact area 206 on the cooled busbars 201, 202 to plugs 401, 402.

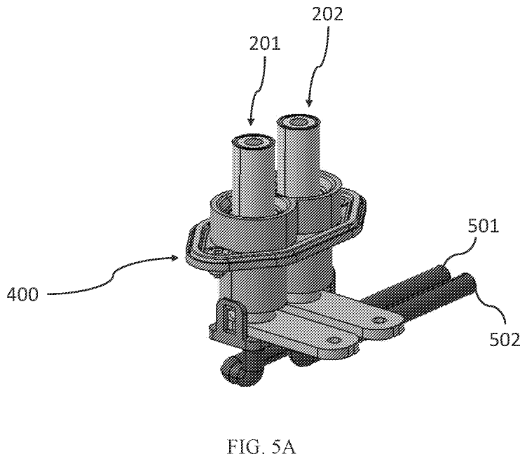

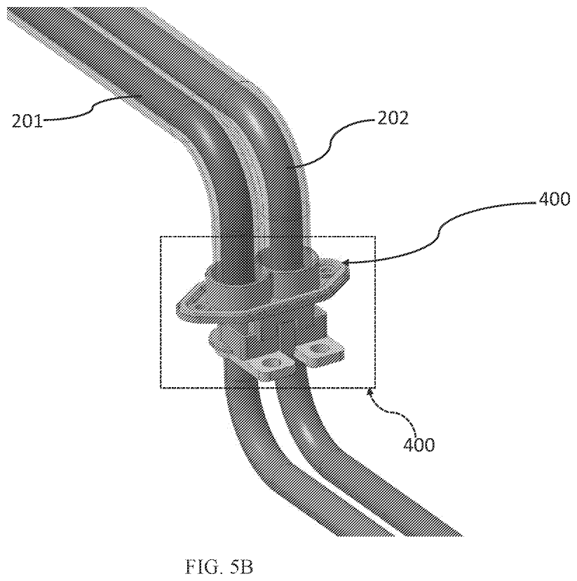

FIGS. 5A and 5B illustrate a pair of cooled busbars 201, 202 connected to a load. In some embodiments, for example as shown in FIG. 5A, a liquid can be circulated in the cooled busbars 201, 202 by receiving the liquid from a liquid source, such as a liquid reservoir. For example, the pair of cooled busbars 201, 202 can be connected with the liquid reservoir via liquid pipelines 501,502 so the liquid can be supplied to the one of the pair of cooled busbars 201, 202 and can be circulated in the cooled busbars 201, 202. FIG. 5B illustrates one embodiment of liquid circulation. In one example, the liquid may be supplied from the first fitting member 408 of the connecting unit 400 shown in FIG. 4C and circulated through the first cooled busbar 201, the U-Loop 311 shown in FIGS. 3A-3C, and the second cooled busbar 202 and returned to the second fitting member 409 of the connecting unit 400 shown in FIG. 4C. In another embodiment, the liquid may be supplied from the second fitting member 409 and returned to the first fitting member 408. The liquid 227 circulating direction may be based on the geometry of the electric vehicle.

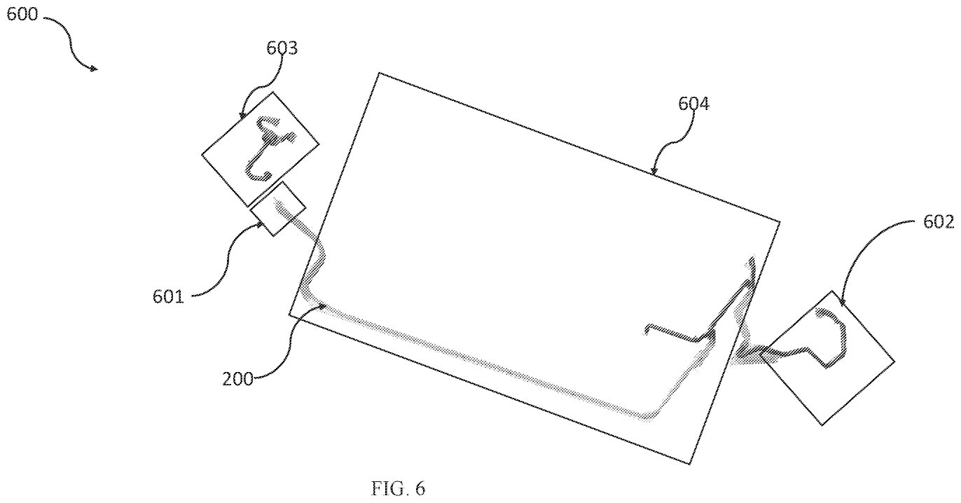

FIG. 6 illustrates an example of electrical power and coolant distribution system 600 using the pair of cooled busbars 200. As illustrated, the pair of cooled busbars 200 can distribute electrical power and circulate liquid between components. For example, in an electric vehicle, the pair of cooled busbars 200 can extend from a battery pack 604 to a front-drive unit 601, a rear-drive unit 602, and an electric vehicle's electrical power conversion system (PCS) 603. The cooled busbar 200 distributes electric electrical power and circulates a coolant. In the electrical power and coolant distribution system 600, a separate coolant hose is not included next to the pair of cooled busbars 200. This can eliminate a need for parallel coolant lines from certain previous designs. The illustration shown in FIG. 6 is not merely provided for an example purpose, and the present disclosure is not limited to the electric vehicle power distribution system, Any suitable principles and advantages of the electrical power distribution system of FIG. 6 can be applied to any other suitable electrical power distribution system.

Embodiments of the present disclosure relate to a busbar for the distribution of electrical energy and coolant between components in an electric vehicle. In many existing electric vehicles, there are multiple liquid-cooled components dispersed throughout the vehicle that utilize and/or store electrical energy. Examples of such components include, without limitation, battery packs, power conversion and/or distribution boxes, inverters, motors, etc. Traditionally, these components have utilized separate inputs and outputs for coolant and electrical energy, resulting in parallel runs of power and coolant between each element in the powertrain.

By combining conduits for distributing electrical energy and coolant into a single assembly, a thermal dynamic busbar enables a more efficient, smaller, and less expensive powertrain. Cooled busbars can connect static components and/or connect dynamic components, such as drive units.

The core of the cooled busbar can be an insulated coolant conduit. The insulated coolant conduit can be a homogenous isolative material (e.g., nylon, polyethylene (PE), cross-linked polyethylene (XPLE), polyvinyl chloride (PVC), silicone, etc.). The homogenous isolative material can be formed by any suitable process, such as extrusion, injection molding, blow molding, etc. In some other applications, the insulated coolant conduct can include a conductive material (e.g., aluminum, copper, etc.) with an electrically isolative (e.g., nylon, PE, XPLE, PVC, silicone, etc.) outer coating. The outer coating can be formed with any suitable process, such as powder coating, dip coating, forming a sleeve, heat shrinking, coextrusion, etc.

The coolant conduit can serve the dual purpose of carrying coolant between the source and destination and also absorbing some of the heat generated by the flow of electrical energy in the outer conducting layers of the busbar.

The coolant conduit can contain single or multiple sealed volumes and can carry coolant in either one or both directions. The coolant conduit is surrounded by a conductive layer (e.g., aluminum, copper) that carries electrical energy from a source to a load. The coolant conduit can include any suitable cooling medium, such as a liquid coolant, air, a phase change material (e.g., hydrated salts or paraffin wax), or the like. The conductive layer can be implemented in accordance with any suitable principles and advantages of the rigid conductors disclosed herein. An insulation layer (e.g., nylon, PE, silicone) can be around the conductive layer. The insulation layer can be assembled by any suitable method, such as heat shrinking, coextrusion, extrusion and bonding, injection molding, etc. Additional conductive and insulating layers can be included around an inner conductive layer and insulating layer in a cooled busbar, depending on the number of electrical paths desired between the ends of the busbar. An outer conducting layer (e.g., aluminum, copper, conductive thermoplastics) can be included outside one or more primary conducting paths to function as electromagnetic shielding layer. The outer conducting layer can also serve as a physical and environmental barrier. The outer conducting layer can be implemented in accordance with any suitable principles and advantages of the shielding layers disclosed herein.

Multilayer cooled busbars disclosed herein can increase the efficiency of electric powertrains in terms of one or more of cost, mass, or space by combining electrical and coolant pathways into a single layered assembly.

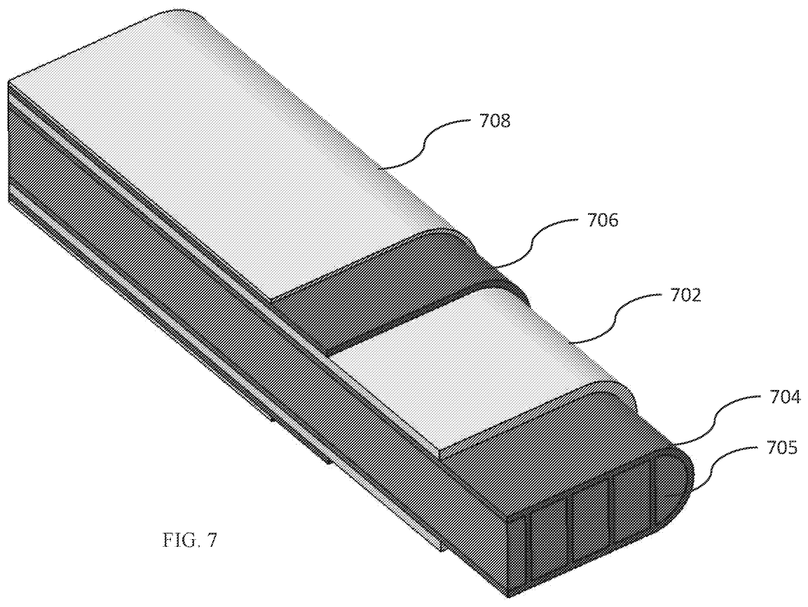

Examples of multilayer cooled busbars will be discussed with reference to FIGS. 7-12. Illustratively, these multilayer cooled busbars can be in a pathway between a first liquid cooled component of an electric system configured to store electrical energy and a second liquid cooled component of the electric system that is configured to use electrical energy. For example, the electric system can be in an electric vehicle. Alternatively or additionally, these multilayer cooled busbars can be in a pathway between a charging port of an electric vehicle and a battery of the electric vehicle. Any suitable principles and advantages of these multilayer cooled busbars can be implemented together with each other and/or with any other busbars disclosed herein. Any suitable principles and advantages of the electric systems disclosed herein can be applied to any other suitable electric systems. The present disclosure describes the electric system with an example of an electric vehicle for illustration purposes.

FIG. 7 illustrates a cooled busbar according to an embodiment. This cooled busbar as shown in FIG. 7 can implement one or more features described in above, such as one or more features discussed above with reference to one or more of FIGS. 1, 2A-2F, and 6. Moreover, the cooled busbar shown in FIG. 7 can be connected to the U-Loop adaptor 320 shown in FIGS. 3A-3C and/or the connecting unit 400 shown in FIGS. 4A-4C. Such connection may involve a structural modification of the U-Loop adaptor 320 and the connecting unit 400. The cooled busbar shown in FIG. 7 can be a single conductor cooled busbar. The illustrated busbar has two flat sides. As illustrated in FIG. 7, the cooled busbar includes a conductor 702, a tube layer 704 with conduits 705 for coolant to flow through, an insulating layer 706, and a shielding layer 708. The insulating layer 706 and other insulating layers disclosed herein can be electrically insulating layers. These insulating layers can each be referred to as an insulation layer. The insulating layer 706 and/or other insulating layers disclosed herein can be implemented in accordance with any suitable principles and advantages of the insulation layer 224 and/or 222. The tube layer 704 includes an electrical insulation layer. The conductor 702 can carry a high voltage for electrical power distribution in an electric vehicle. The number of the conduits 705 included in a cooled busbar can be selected based on specific application.

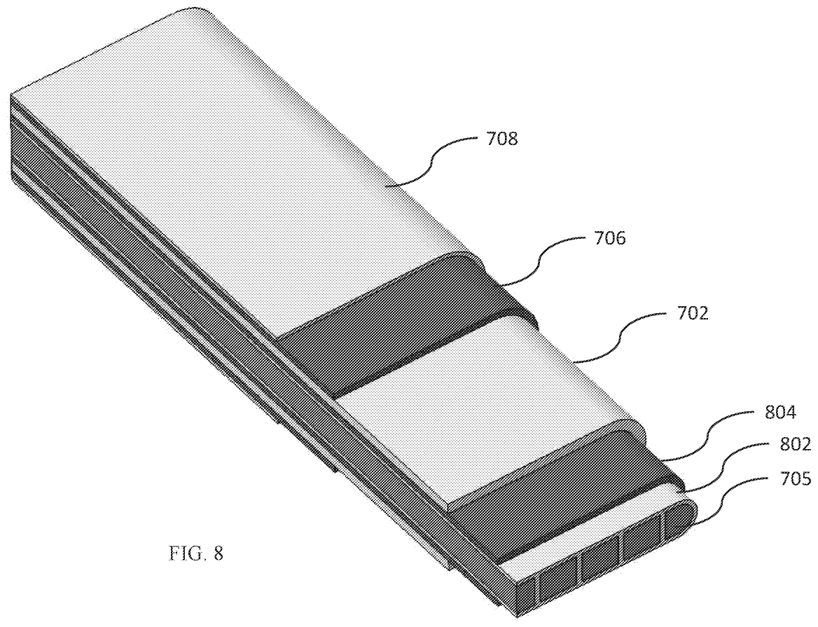

FIG. 8 illustrates a cooled busbar according to an embodiment. This cooled busbar is a single conductor thermal busbar with a conductive coolant tube layer. As illustrated in FIG. 8, the cooled busbar can include a conductive coolant tube layer 802 with conduits 705 for coolant to flow through. The conductive coolant tube layer 802 can be surrounded by an insulating layer 804 that electrically insulates the conductive coolant tube layer 802 from the conductor 702. The insulating layer 804 can be surrounded by the conductor 702. The conductor 702 can be surrounded by an insulating layer 706. The insulating layer 706 can further be surrounded by the shielding layer 708.

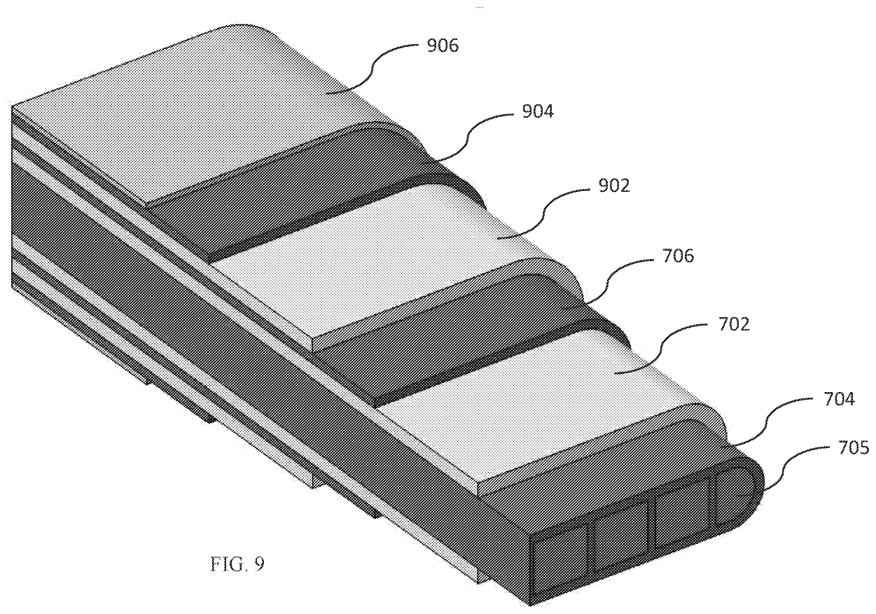

FIG. 9 illustrates a cooled busbar according to an embodiment. This cooled busbar is a multilayer cooled bus bar and can include more than one conductive layer. As illustrated in FIG. 9, the cooled busbar can include a second conductor 902, in addition to the conductor 702. The cooled busbar shown in FIG. 9 can include the conductor 702, the tube layer 704 with conduits 705 for coolant to flow through, and the insulating layer 706. The insulating layer 706 can be surrounded by a second conductor 902. The second conductor layer 902 can be surrounded by the second insulating layer 904. The second insulating layer 904 can be surrounded by the shielding layer 906. The conductors 702, 902 can provide separate electric power distribution paths in the cooled busbar of FIG. 9. Although two conductors 702 and 902 are shown in FIG. 9 for illustrative purposes, three or more conductors that are electrically isolated from each other can be implemented in certain applications.

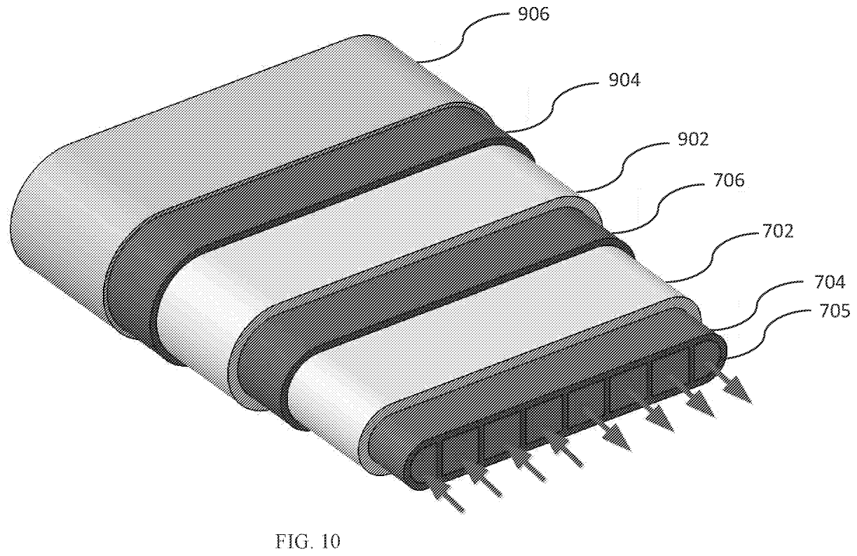

FIG. 10 illustrates an embodiment of the cooled busbar of FIG. 9. In FIG. 10, bidirectional coolant flow is illustrated. As illustrated in FIG. 10, a cooled busbar with multiple fluid pathways (e.g., conduits 705) can have fluid flow in different directions in the fluid pathways. In certain applications, coolant can concurrently flow in different directions within different respective fluid pathways of a cooled busbar. For example, coolant can concurrently flow in different (e.g., opposite) directions in different conduits 705 of the cooled busbar of FIG. 10.

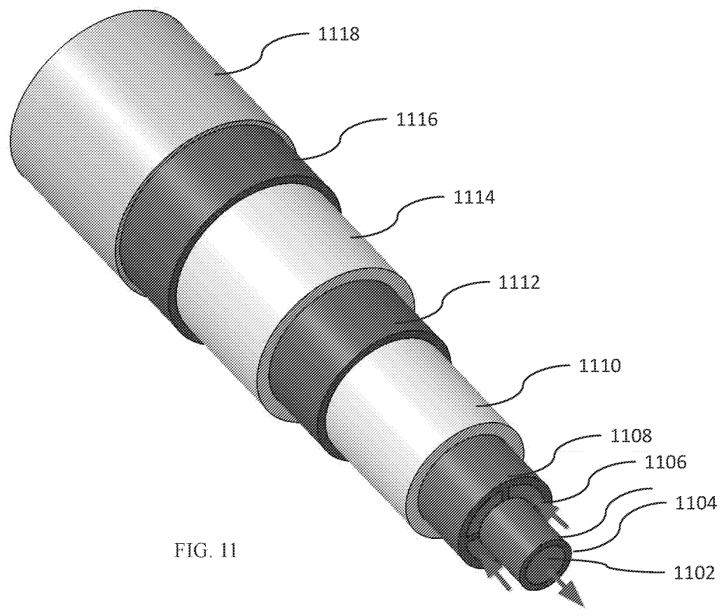

FIG. 11 illustrates a cooled busbar according to an embodiment. This cooled busbar shown in FIG. 11 can implement one or more features described above, such as one or more features discussed with reference to one or more of FIGS. 1, 2A-2F, and 6-10. Moreover, the cooled busbar shown in FIG. 11 can be connected to the U-Loop adaptor 320 shown in FIGS. 3A-3C and/or the connecting unit 400 shown in FIGS. 4A-4C. Such connection may involve a structural modification of the U-Loop adaptor 320 and/or the connecting unit 400. The cooled busbar of FIG. 11 has a round cross-sectional shape, a plurality of conductors, and bidirectional coolant flow.

As illustrated in FIG. 11, a center conduit 1102 can be surrounded by a first tube layer 1104. The first tube layer 1104 can be surrounded by second conduits 1106. The number of conduits in the second conduits 1106 can be selected based on a specific application. One or more of the second conduits 1106 can have a different coolant flow direction than the central conduit 1102. The different coolant flow direction can be an opposite coolant flow direction. In some instances, two conduits of the second conduits 1106 can have different respective coolant flow directions. The second conduits 1106 can be surrounded by a second tube layer 1108. The second tube layer 1108 can be surrounded by a first conductor 1110. The first conductor 1110 can be surrounded by the first insulating layer 1112. The insulating layer 1112 can be surrounded by the second conductor layer 1114. The second conductor 1114 can be surrounded by a second insulating layer 1116. The second insulating layer 1116 can be surrounded by a shielding layer 1118. Any suitable number of conductors can be implemented for a specific application.

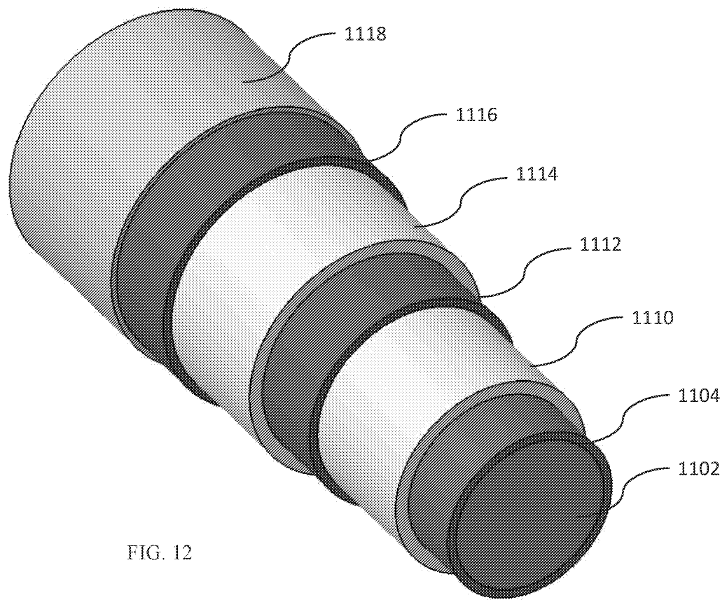

FIG. 12 illustrates a cooled busbar according to an embodiment. This cooled busbar is similar to the cooled busbar described in FIG. 11, except that the cooled busbar of FIG. 12 has a single coolant path. As illustrated in FIG. 12, a center conduit 1102 can be surrounded by a first tube layer 1104. The first tube layer 1104 can be surrounded by a first conductive layer 1110 without intervening conduits.

In some embodiments, a busbar has one or more hollow portions and an inner rigid conductor. Such a busbar can include an insulation layer between one or more hollow portions and the inner rigid conductor. Accordingly, one or more hollow portions can be outside of the insulation layer. A cooling medium can flow through one or more hollow portions.

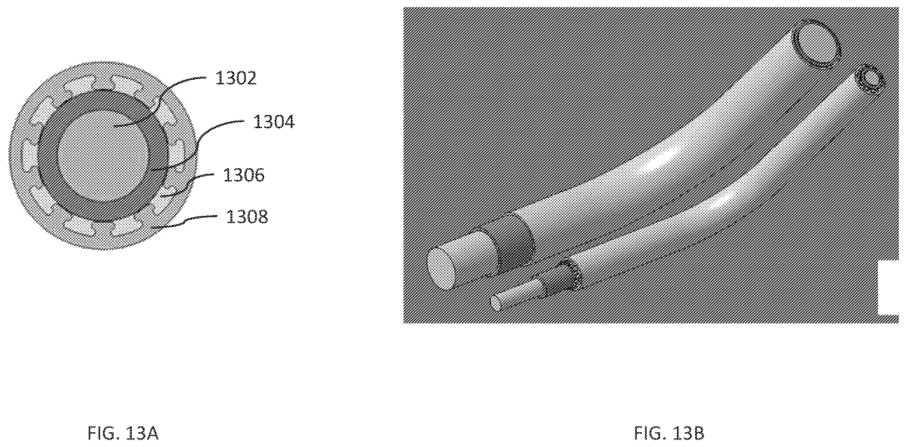

FIG. 13A illustrates a cross-sectional view of a busbar according to an embodiment. This busbar is a round busbar with an inner rigid conductor 1302 and an outer conductor 1308. There is an insulating layer 1304 between the inner and outer conductors 1302 and 1308, respectively. The outer conductor 1308 can surround the insulating layer 1304 and include extrusions with cooling channels, where the extrusions can be hollow portions 1306 configured for fluid (e.g., liquid coolant) to flow therethrough. The hollow portions 1306 can be included around an outer diameter of the insulating layer 1304. Any suitable number of hollow portions can be implemented for a specific application. Cooling of the inner rigid conductor 1302 and outer conductor 1308 can be provided by a coolant flowing through the cooling channels of the hollow portions 1306 that are outside of the insulation layer 1304. The coolant flow direction in each of the hollow portions 1306 can be the same direction or a different direction.

FIG. 13B illustrates a busbar corresponding to FIG. 13A compared to a busbar with a solid outer conductor. The cooled busbar of FIG. 13A can be implemented with one or more suitable features of the cooled busbars described herein. For example, the cooled busbar of FIG. 13A can include one or more additional layers, such as one or more additional insulating layers, one or more conductors, one or more shielding layers, or a coloring layer. Moreover, the cooled busbar of FIG. 13A can be connected to the U-Loop adaptor 320 of FIGS. 3A-3C and/or the connecting unit 400 of FIGS. 4A-4C. Such connection may involve a structure modification of the U-Loop adaptor 320 and/or the connecting unit 400.

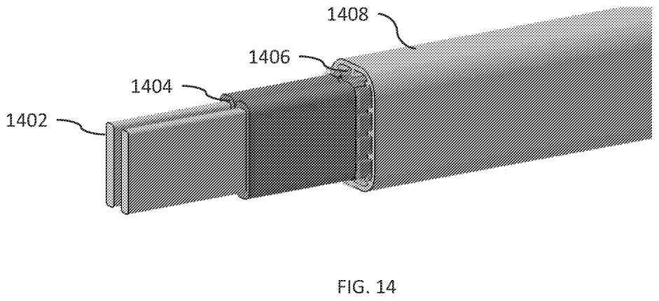

FIG. 14 illustrates a cooled busbar according to an embodiment. The cooled busbar shown in FIG. 14 can have similar features to the cooled busbar shown in FIGS. 13A and 13B. The cooled busbar shown in FIG. 14 can be a flat stacked busbar with a plurality of inner rigid conductors 1402. The cooled busbar of FIG. 14 can include multiple inner rigid conductors 1402 within a single rigid shielding layer. The inner rigid conductors 1402 can include both a positive conductor and a negative conductor. Accordingly, a single cooled busbar can include a positive conductor and a negative conductor, Each inner rigid conductor 1402 can be surrounded by an insulating layer 1404. The insulating layers 1404 can be surrounded by an outer conductor 1408. In some instances, the outer conductor 1408 can be a shielding layer. Alternatively or additionally, a shielding layer can be included around the outer conductor 1408. Hollow portions of the busbar are included outside of the insulating layer 1404 of each of the inner rigid conductors 1402. Coolant can flow through the hollow portions to cool the inner rigid conductors 1402. The hollow portions 1406 can be located between the outer conductor 1408 and the insulating layers 1404. The hollow portions 1406 can implement bidirectional fluid flow in certain applications. Any suitable number of hollow portions can be implemented for a particular application. Coolant can flow through conduits defined by the hollow portions 1406 to cool the inner rigid conductors 1402 and the output conductor 1408. The cooled busbar of FIG. 14 can implement one or more suitable additional features of the cooled busbars disclosed herein, such as one more additional conductors, one or more additional insulating layers, one or more shielding layers, or a coloring layer. Moreover, the cooled busbar shown in FIG. 14 can be connected to the U-Loop adaptor 320 shown in FIGS. 3A-3C and/or the connecting unit 400 shown in FIGS. 4A-4C. Such connection may involve a structural modification of the U-Loop adaptor 320 and/or the connecting unit 400.

Unless the context clearly requires otherwise, throughout the description and the claims, the words “comprise,” “comprising,” “include,” “including” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “may,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments.

The foregoing description has been described with reference to specific embodiments. However, the illustrative discussions above are not intended to be exhaustive or to limit the inventions to the precise forms described. Many modifications and variations are possible in view of the above teachings. Others skilled in the art are thereby enabled to best utilize the techniques and various embodiments with various modifications as suited to various uses.

Although the disclosure and examples have been described with reference to the accompanying drawings, various changes and modifications will become apparent to those skilled in the art. Such changes and modifications are to be understood as being included within the scope of the disclosure.

1. An electric power distribution system comprising:
a busbar comprising a rigid conductor configured to carry current from a source to a load, a hollow portion surrounded by the rigid conductor and configured to have a cooling medium flow therethrough, an inner tube layer positioned between the rigid conductor and the hollow portion, an insulation layer, and a shielding layer positioned such that the insulation layer is between the rigid conductor and the shielding layer.

2. The electric power distribution system of claim 1, wherein the rigid conductor comprises at least one of aluminum or copper.

3. The electric power distribution system of claim 1, wherein the inner tube layer is configured to protect the rigid conductor from corrosion from the cooling medium.

4. The electric power distribution system of claim 3, wherein the busbar further comprises an electrically insulating layer, wherein the electrically insulating layer is positioned between an inner diameter of the rigid conductor and the inner tube layer.

5. The electric power distribution system of claim 1, further comprising a second hollow portion that is outside of an outer diameter of the rigid conductor.

6. The electric power distribution system of claim 1, wherein the rigid conductor has a first end and a second end, and the first end and the second end each have an electrical contact area.

7. (canceled)

8. The electric power distribution system of claim 1, wherein the insulation layer comprises at least one of cross-linked polyethylene (XLPE), polyvinyl chloride (PVC), nylon, silicone, thermoplastic, or thermoset plastic.

9. (canceled)

10. (canceled)

11. The electric power distribution system of claim 1, wherein the busbar is shaped for inclusion in an electric vehicle, and wherein the busbar is shaped to conform to in-vehicle packaging and extends between a charging port/inlet to a vehicle battery.

12. The electric power distribution system of claim 1, further comprising a second busbar comprising a second rigid conductor, a second hollow portion, a second insulation layer, and a second shielding layer.

13. The electric power distribution system of claim 12, further comprising a coolant source, wherein the cooling medium flows from the coolant source to the busbar and from the second busbar to the coolant source.

14. The electric power distribution system of claim 12, further comprising a U-Loop adaptor connected to the busbar and the second busbar, wherein the second busbar is configured to provide return flow for the cooling medium.

15. The electric power distribution system of claim 1, further comprising a reservoir and a pump together configured to provide the cooling medium to the hollow portion of the busbar.

16. (canceled)

17. The electric power distribution system of claim 1, further comprising a charge-port connecting unit configured to connect the busbar to the source.

18. An electric vehicle comprising:
a battery;
a charge port; and
a busbar comprising a rigid conductor configured to carry current in an electrical path from the charge port to the battery, a hollow portion surrounded by the rigid conductor and configured to have a cooling medium flow therethrough, an inner tube layer positioned between the rigid conductor and the hollow portion, an insulation layer, and a shielding layer positioned such that the insulation layer is between the rigid conductor and the shielding layer.

19. A busbar comprising:
a conductor configured to carry electrical energy between components of an electric powertrain;
a conduit for a cooling medium, wherein the conduit is surrounded by the conductor, and wherein the conductor and the conduit are both part of a single busbar assembly, the busbar being a rigid busbar; and
a tube layer surrounding the conduit, the tube layer positioned between the conduit and the conductor.

20. The busbar of claim 19, further comprising a second conduit.

21. (canceled)

22. The busbar of claim 19, further comprising a second conductor and an insulating layer, the insulating layer positioned between the conductor and the second conductor.

23. (canceled)

24. The busbar of claim 19, further comprising a shielding layer surrounding the conductor and an insulation layer positioned between the conductor and the shielding layer.

25. (canceled)

26. The busbar of claim 19, wherein the tube layer comprises an electrically insulating layer configured to electrically isolate the conductor and cooling medium flowing through the conduit.

27. The busbar of claim 26, wherein the electrically insulating layer comprises at least one of polyethylene, nylon, polyvinyl chloride, silicone thermoplastic, or thermoset plastic.

28. (canceled)
